(19) United States
(12) Patent Application Publication
(10) Pub. No.: US 2025/0126014 A1
(43) Pub. Date: Apr. 17, 2025

(54) IMPLEMENTATION OF A DISTRIBUTED LAYER TWO SWITCH

(71) Applicant: ACiiST Smart Networks Ltd., Kfar Varburg (IL)

(72) Inventors: Sagi Gurfinkel, Kfar Varburg (IL); Ran Kalif, Bitzaron (IL); John W. Ralston, Glasgow (GB); Elad Hoss, Nes Harim (IL)

(73) Assignee: ACiiST Smart Networks Ltd., Kfar Varburg (IL)

(21) Appl. No.: 18/687,270

(22) PCT Filed: Aug. 29, 2022
(86) PCT No.: PCT/IB2022/058075

§ 371 Date: Feb. 27, 2024

Related U.S. Application Data
(60) Provisional application No. 63/260,677, filed on Aug. 27, 2021.

(51) Int. Cl. H04L 41/0806; H04L 41/0895

(52) U.S. Cl. CPC H04L 41/0806; H04L 41/0895

(57) ABSTRACT

A distributed network that may include multiple links; and multiple physical nodes that in communication with each other via the multiple links, to form multiple redundant paths, wherein at least some of the redundant paths form a daisy chain; wherein the multiple physical nodes comprise output ports configured to interface with external hosts. The multiple physical nodes are configured to supports software defined networking (SDN).

### CROSS REFERENCE

This application claims priority from US provisional patent filing date Aug. 28, 2021 Ser. No. 63/260,677 which is incorporated herein by reference.

### BACKGROUND OF THE INVENTION

Smart City network require flexible, high-performance connectivity everywhere in streets, parks, campuses and practically harsh environment, environment that is more ready for industrial networks, where, typically, nodes are connected in a daisy chain or rings that dictate strict configuration and timing. This strict and rigid connectivity requirement and behavior are unacceptable for smart cities that require a huge variety of devices as well as many functions that are not available in industrial networks such as virtualization, full manageability and the like.

FIG. 1 illustrates an example of a prior art fiber based local area network (LAN) 10 implemented using fibers and a three switching hierarchies that include level one 2 ×−1 GE, level 2 4×16−1GE, and level 3 16×16-FE equipment spread over about 500 posts, about 550 cables having an average length that exceeds 200 meters, the LAN is limited to 500 internet of things (IOT) devices, and includes about 30 switch boxes and about 200 junction boxes of post. The installation of such a LAN requires extensive excavations (12) and has a major impact on a vast number of roads and sidewalks.

The is a growing need to provide a outdoor or urban network that is scalable, may support a vast number of users, may support clients of different types, and may have a much smaller amount of excavations, and nodes.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a prior art LAN;

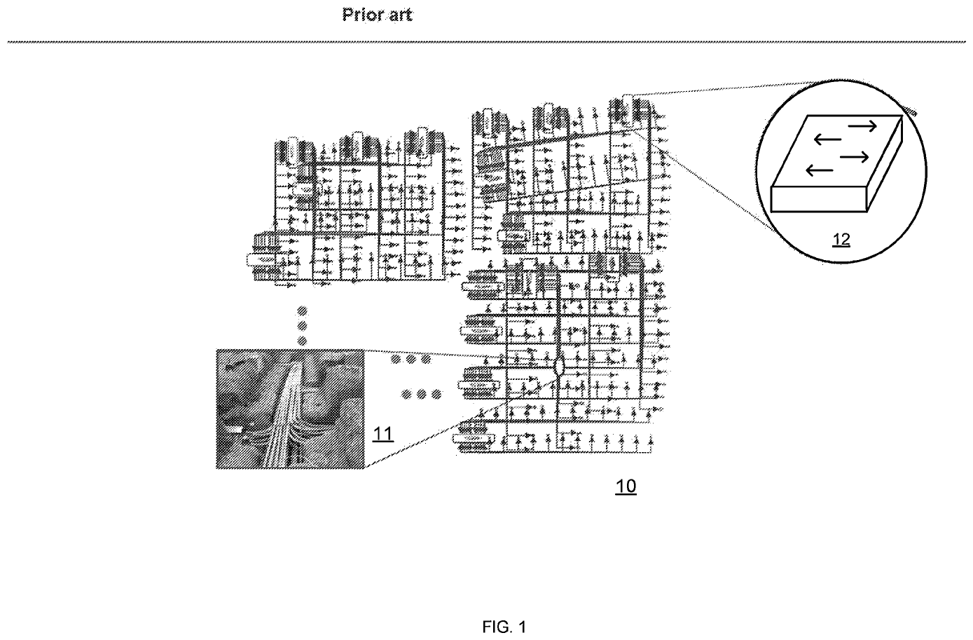

FIG. 2 illustrates an example of a network;

FIG. 3 illustrates an example of a network;

FIG. 4 illustrates an example of a network;

FIG. 5 illustrates an example of a network;

FIG. 6 illustrates an example of a smart pole;

FIG. 7 illustrates an example of smart poles;

FIG. 8 illustrates an example of a physical node;

FIG. 9 illustrates an example of a virtual distributed SDN layer two switch and multiple nodes;

FIG. 10 illustrates an example of a network;

FIG. 11 illustrates an example of a MESI database;

FIG. 12 illustrates an example of communication;

FIG. 13 illustrates an example of different metadata layers; and

FIG. 14 illustrates an example of different metadata layers.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference in the specification to a method should be applied mutatis mutandis to a system capable of executing the method and should be applied mutatis mutandis to a non-transitory computer readable medium that stores instructions that once executed by a computer result in the execution of the method. The system may be the distributed network or a physical node of the distributed network.

There may be provided a method for operating any distributed network illustrated in the specification.

There may be provided a method for operating any physical node network illustrated in the specification.

The network is also referred to as urban network, distributed network, and the like.

The suggested network may be applied to smart city edge networks and may define a network topology structured as mesh of daisy-chains that allow deployment of large urban and other outdoor networks faster better and cheaper.

This network leverages daisy chains that are meshed to form complex multi-ring with multiple redundancy paths to allow robust industrial and urban Ethernet networks. But using managed switches that are software managed using virtually distributed management and configurator (VDNC) to provide a classic LAN behavior on top and a meshed daisy chain network topology with powerful redundancy, low latency and high timing determinism.

The network support the urban needs of minimal wiring, short latencies, strict timing and synchronization, high availability together with benefits of generic LAN (Ethernet “star” topology network) which are capable of many nodes on logically flattened hierarchies, virtualization and virtual sub networks and dynamic configuration.

The network may provide the full benefits when one or more of the lists below is needed.
a. Fully managed LAN with virtualization, subgroups, and sharing of physical resources by few virtual users etc.
b. May be installed in harsh environment (for example outdoor environment) such as roads and streets of a city
c. Required a minimal amount of wiring and minimal network equipment.
d. It precise, deterministic, timing with high availability.
e. Minimal disruption to life during installation (roads blockages, digging and trenching roads and sidewalks etc.) and requires minimal maintenance.
f. Is highly available, and immune to multiple failures.
g. Support multiple smart devices distributed over large areas.
h. May be used to turn existing light posts to bases of communication and interfaces with smart devices.
i. Scalable and may extent the network without switch boxes, can add new physical nodes in a plug and play manner.
j. Self-configurable.
k. Self-managed.
l. May use standard LAN protocols such as Ethernet, may use standard cables, may easily connect with OTS IOT devices.
m. Has M2M capabilities.
n. Reliable.
o. A single network cable may serve all premises applications.
p. Is distributed and without a single point of failure.
q. Does not require central switch boxes.

This network has a “daisy chain mesh” topology for urban Ethernet networks enables having many nodes on a single network hierarchy, which combine many subgroups into one mesh. The network provided a full managed network with standard interface, allowing multi users with isolation and protection by admin configuration. The network leverages seamless redundancy for multiple purposes thus also improves the overall immunity of the system to failures

The network includes the following components:
a. Physical nodes that may include at least 4 ways network switch with 2 or 3 ports used for daisy chaining or connection to another daisy chain and at least 1 port used for local network termination
b. Daisy chain mesh network connected with mostly 2 ways bridges and at least two 3 ways bridges allowing to “short” two distant parts of the daisy chain or different locations on the ring

The network nodes support Virtual Distributed Network Configurator (VDNC) or Central Network configurator (CNC) that, coherently, configures all the physical nodes, read their mutual and local statuses and configurations and can reconfigure the bridges routing tables.

Each physical node may include three “mesh” ports to be used as the backhaul of the “distributed switch”, may include at least one host port that is used to redirect traffic for determination at the location of the node, may bridge between any pair of the three “mesh” ports connected to the network, may have a local client CPU that provides the local functionality of the distributed switch, acting as VDNC or as the client of the CNC (Central Network Configurator), may be capable of implementing seamless redundancy functionality on traffic routed between the “host” interface and the “daisy chain” network (key functionality is duplication and de-duplication of traffic at wire rate), may cooperate with the other parts of the meshed network to fully virtualize the “distributed switch”, as well as handle local taken down, wake up, commissioning reset etc., and may report status and configuration to the VDNC

A subset of connections between physical nodes may create a ring of at least three nodes with at least three wires (the first ring) among all nodes without repeating any node or wire. Other physical nodes have at least two paths to the main rings either directly or through a daisy chain or through another daisy chain that meets the requirement of two paths to the first ring.

The VDNC can calculate at least two orthogonal paths from any talking node to any listener node through the network. While these two paths should use the shortening connections to reduce latency the overall latency of the system is much less then with one ring only. In general, a short may reduce the latency of the worst out of two orthogonal paths by almost 50%. The VDNC should configure all nodes on the path, and their local routing table, scheduling policy and any needed networking and routing attribute.

### Network Structuring Algorithm

The algorithm ma start by deciding on Number of “Redundant Wires” (NoRW) per budget, area, and latency goals (typical rate would be 1:10, i.e., on every 10 units daisy chain segment connect wire to another daisy chain segment)

Connect physical nodes in a ring topology using two of the “mesh ports” with the shortest overall wire length (algorithm for the connection that is not part of the solution, but “traveling sale person” method may be a good example) (The first ring)

Connect the rest of the physical nodes to each other as daisy chain composed of one or more units, the two sides of the daisy chain should be connected to the first ring or to another daisy chain the obey this rule respectively overall number of redundant connections (2^{nd} connection of daisy chain to another daisy chain/ring) should seek the ratio mentioned above.

Per area/neighborhood. When doing shorts find a pair of nodes that are physically near but node count between them may be at least TNC/NoRW *EF where TNC is the “Total Node Count” on the network, NoRW is the number of redundant wires decided and EF is an Efficiency Factor between 0 and 1 providing a tradeoff between redundancy count and ideal latency achievable with this number of jumpers. EF should typically be in the range of 0.5 to 0.8 to allow shorter wiring at cost of minor latency. To compensate for the less then optimal jumpers' number of jumpers may be increased and same latency can be achieved with overall less wire length.

### Virtual Network Distributed Configurator

The VDNC is a process that can run on each node in the network or on multiple physical nodes concurrently.

The VDNC calculates routing and has the full network visibility regardless on which physical node is physically running the VDNC compute thread.

The network replicates the network state and configuration with an algorithm that guarantees coherency among all physical nodes thus guarantying that any new command by the VDNC will provide the same results no matter what CPU and physical node is it running on top.

An algorithm that manages synchronization may be is similar to algorithms used for multiprocessors memory cashing (i.e., MESI etc.).

On any change in configuration state the Local thread triggers network synchronization on the configuration

On typical urban network the number of changes in configuration is relatively low so large networks can maintain coherent replicated data base.

There may be provided a distributed network that may include multiple links and multiple physical nodes that in communication with each other via the multiple links, to form multiple redundant paths. At least some of the redundant paths form a daisy chain. The multiple physical nodes may include output ports configured to interface with external hosts. The multiple physical nodes may be configured to supports software defined networking (SDN).

An external host may be a device or unit or system that is configured to communicate. Examples of external hosts may include sensors, mobile devices, IOT devices, wireless communication units, wired communication units, and the like.

At least some link portions of the least some of the multiple links may be underground link portions—that are installed underground or a configured to be installed in the ground.

The multiple physical nodes may be configured to exchange, in real time, status information within each other.

The multiple physical nodes may be configured to exchange, in real time, physical node health information within each other.

A physical node (or some of the physical nodes or all physical nodes) of the multiple physical nodes may be configured to send, in real time, physical node health information regarding the physical node and regarding neighbors of the physical node.

The distributed network may be configured to initialize a new physical node with a health score indicative of an untested physical node (providing a significant low health score), and provide the physical node a valid health score only after the physical node may be active for at least a predefined period. The initialization may be done by the new physical node itself.

The multiple physical nodes may be configured to exchange, in real time, a packet distribution policy with each other. The packet distribution policy may determine allowable targets of communication and forbidden targets of communication.

The multiple physical nodes may be configured to exchange, in real time, configuration information within each other.

The multiple physical nodes may be configured to exchange, in real time, a first type of physical node metadata and to send an indication about a change in a value of a second type of physical node metadata.

The each physical node of the multiple physical node may be configured to reconstruct, in real time, a status of all physical nodes of the multiple physical nodes.

The each physical node of the multiple physical nodes may be configured to define, in real time, two (or more) different paths from the physical node to a target. The target may be an external host, a certain upload link or even another network port.

The each physical node of the multiple physical nodes may be configured to define the two different paths from the physical node to the target, based on a status, generated by the physical node, of all physical nodes of the multiple physical nodes. A selected path should be healthy—should not include physical nodes that have a lower than determined health score.

Each physical node of the multiple physical nodes may be configured to define the two different paths based on a health of physical nodes of the multiple physical nodes.

Each physical node of the multiple physical nodes may be configured to define the two different paths based on load associated with the multiple physical nodes.

Each physical node of the multiple physical nodes may be configured to define, in real time, two different paths from the physical node to a target for traffic of a first class and may be configured to define in real time a single path from the physical node to the target for traffic of a second class.

Each physical node of the multiple physical nodes may be configured to define the two different paths so that the different paths do not share a point of failure.

The multiple physical nodes may be configured to support the SDN without an assistance of an external SDN manager that may be located outside the distributed network.

The multiple physical nodes may be configured to exchange, in real time, physical node metadata regarding the multiple physical nodes, and to reconstruct a status of the multiple physical nodes, wherein the reconstructed status may be associated with access control rules. The access control rules may define whether a status of a certain physical node may be modified, exclusive, shared or invalid.

The multiple physical nodes may be configured to provide an SDN layer two switch.

The multiple physical nodes may include groups of physical nodes may be configured to provide a SDN architecture that may include a service gateway configured to convey packets between hosts of a group of physical nodes, and local access network (LAN) gateway that may be configured to convey packets between hosts of the groups of physical nodes.

There may be provided a distributed network that may include multiple links; and multiple physical nodes that may be in communication with each other via the multiple links. At least two physical nodes of the multiple physical node may be configured to reconstruct, in real time, a status of all physical nodes of the multiple physical nodes; and to define, in real time, two different paths from the physical node to a target.

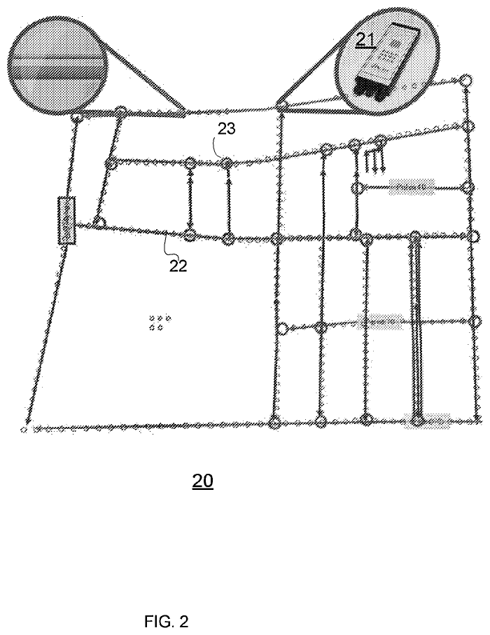

FIG. 2 illustrates an example of a city LAN 20 that includes about 500 posts, about 550 cables—having an average length of less than 30 meters (about one eighth of the prior art cable average length), has no switching boxes, and does not require extensive excavations. The system has relatively simple physical nodes 21 capable of supporting an SDN network. FIG. 2 illustrates nodes 22 that are connected using two mesh ports (their third port may not be used), and nodes 23 that are connected using three mesh nodes (to increase redundancy).

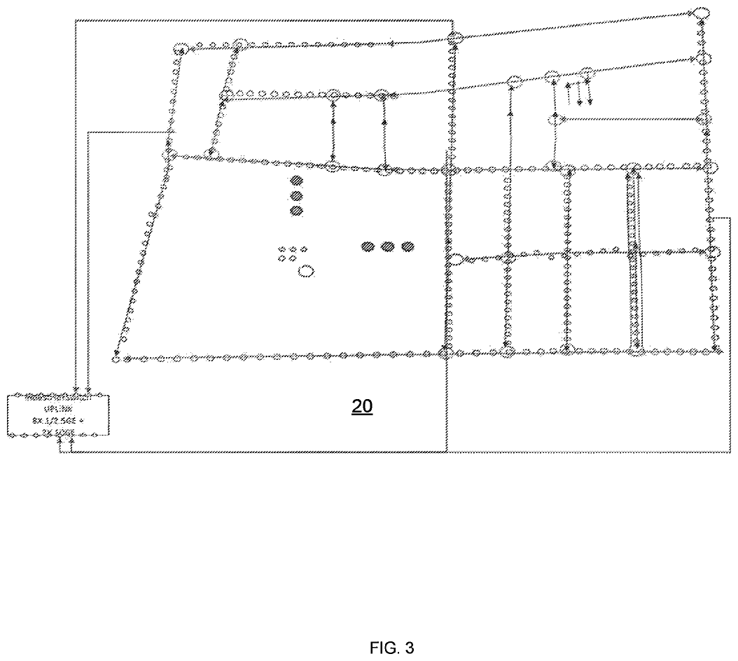

FIG. 3 illustrates an example of a city LAN 20 and its virtual uplink.

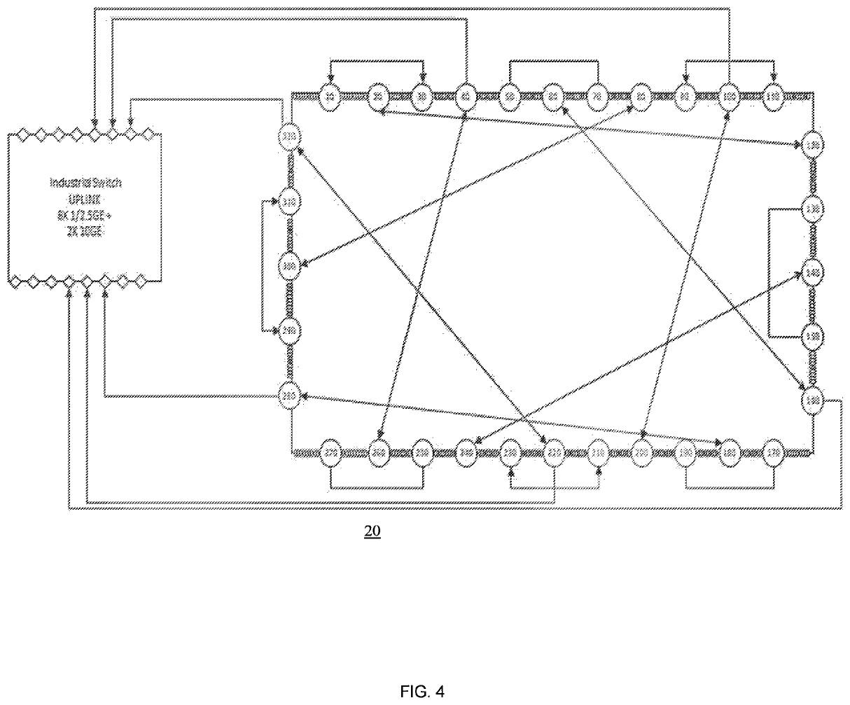

FIG. 4 illustrates another example of a city LAN 20 and its virtual uplink. This figure illustrates a main daisy-chain (that coupled between two mesh ports of physical nodes) and multiple redundant links (coupled between third mesh nodes) that link members of the daisy chain to provide redundancy.

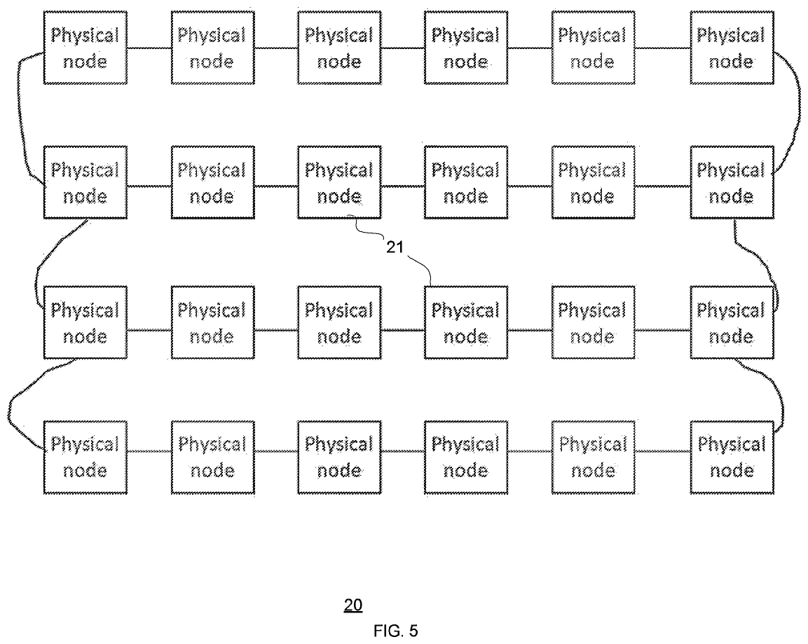

FIG. 5 illustrates another example of a city LAN 20 in which there are multiple daisy chains.

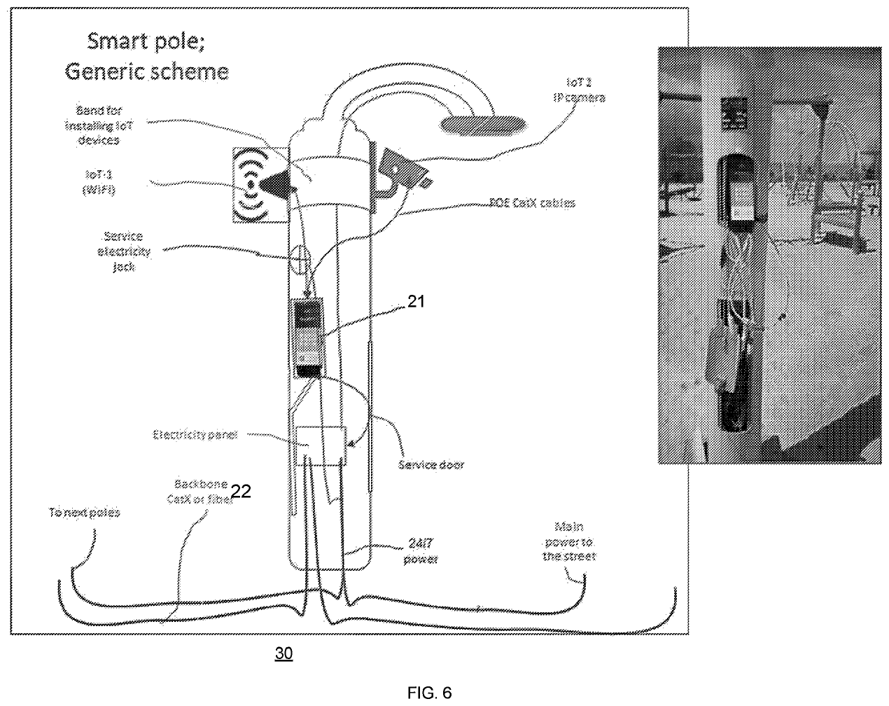

FIG. 6 illustrates an example of a smart pole 30 that include a physical node, IOT Wi-Fi communication unit, a band for installing an IOT device, a IOT camera, a service electricity jack, an electricity panel, service door, power and communication cables for linking the physical node to the next (right side and left side) physical nodes. The communication cable may be a backbone CatX or fiber cable—or any other communication cable.

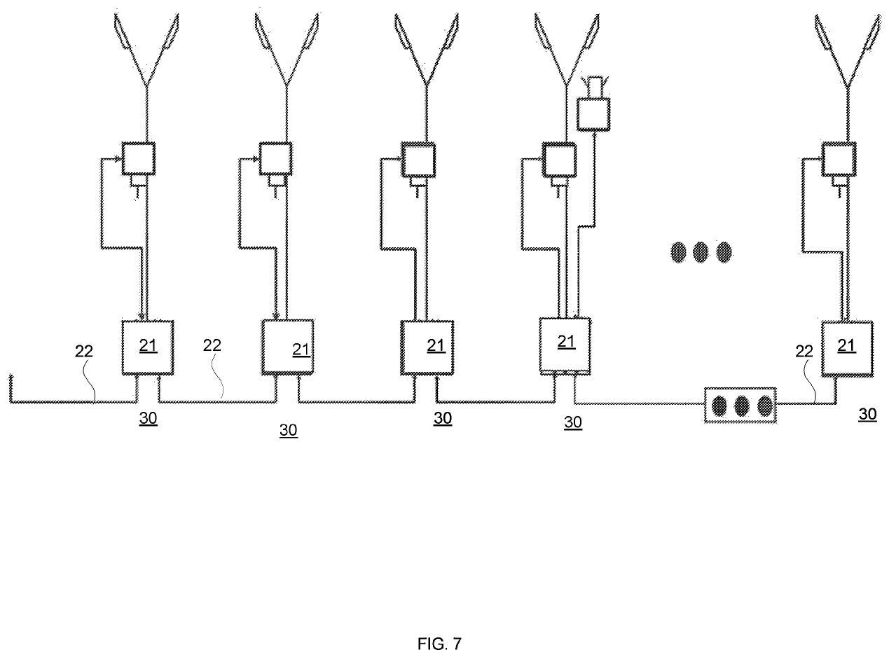

FIG. 7 illustrates daisy chained smart poles 30 such as the smart pole of FIG. 6.

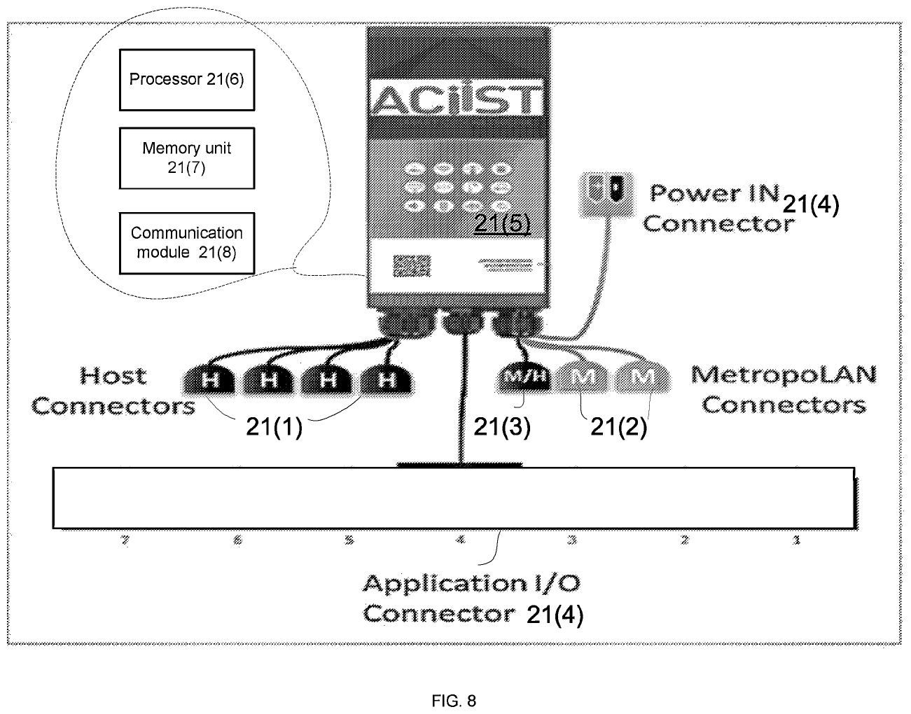

FIG. 8 is an example of a physical node 21 that includes four output ports (“H”) 21(1) for interfacing with hosts, three mesh ports-two 21(2) for daisy chaining the physical node with other physical nodes and a third mesh port (M/H) 21(3) that may be used to interface with a host or to interface with another physical node—as many physical nodes use only two mesh ports to interfaces with other physical nodes. The physical node as a man machine interface such as a keyboard 21(5). The physical node also include an application I/O connector 21(5), has a power in connector 21(4) for receiving power, a processor 21(6), memory unit 21(7) and communication module 21(8) for managing in-physical node communication and communication with hosts and/or other physical nodes.

A physical node may include a communication module that is configured to communicate, via mesh ports of the physical node, with other physical nodes of the distributed network; a memory unit that is configured to store status information regarding a status of the physical node and regarding statuses of the other physical nodes of the distributed network; a processor that is configured to reconstruct in real time, a status of all the other physical nodes; and to define, in real time, two different paths from the physical node to a target.

The physical node may be configured to exchange, in real time, with the other physical nodes, physical node health information of the physical node and of the other physical nodes.

The physical node may be configured to send, in real time, physical node health information regarding the physical node and regarding neighbors of the physical node.

The physical node may be configured to initialize itself, when first activated in the distributed network, a health score indicative of an untested physical node, and provide the physical node a valid health score only after the physical node may be active for at least a predefined period.

The physical node may be configured to exchange, in real time, a packet distribution policy with the other physical nodes.

The physical node may be configured to exchange, in real time, with the other physical nodes configuration information.

The physical node may be configured to send, in real time, to the other physical nodes a first type of physical node metadata and to send in real time, to the other physical nodes, an indication about a change in a value of a second type of physical node metadata.

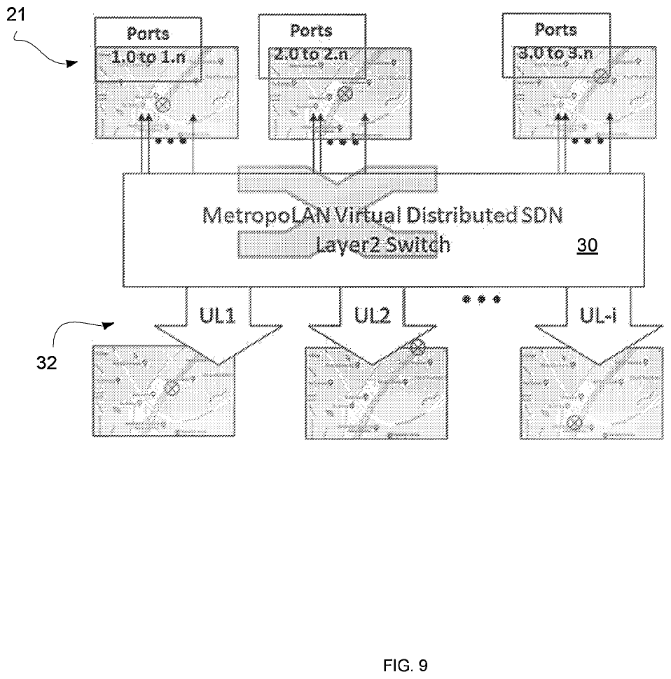

FIG. 9 is an example of a virtual distributed SDN layer 2 switch 30 that is implemented by multiple physical nodes 21 and virtually couples multiple physical nodes (each having multiple ports—n per physical node) to multiple uplinks 32. The physical nodes and their uplinks are positioned at different locations.

The network provides a functional view and behavior of a fully managed city/highway/premise LAN without the mass of equipment, the pains and sensitivities involved in deploying existing outdoor solutions. The network is DSN managed. The physical nodes of the network support distributed serverless managements and there is no need in servers and no single point of failure.

The network may support various communication functionalities such subnetwork, fully configurable, quality of service (QOS), multiple TC, per port configuration and assignments, and exhibits seamless redundancy. The network is constantly monitored and the physical nodes are capable to recover from one or more failures in real time (for example by changing paths within the network in real time).

The network supports real time monitoring of load and load balancing, security at location of the data consummation or production, may perform auto or self commissioning.

The network is IOT ready and is configured to provide seamless connection and co-operation with any standard connected device.

The network is customer friendly—may use standard IT infrastructure and protocols, and is easy to maintain.

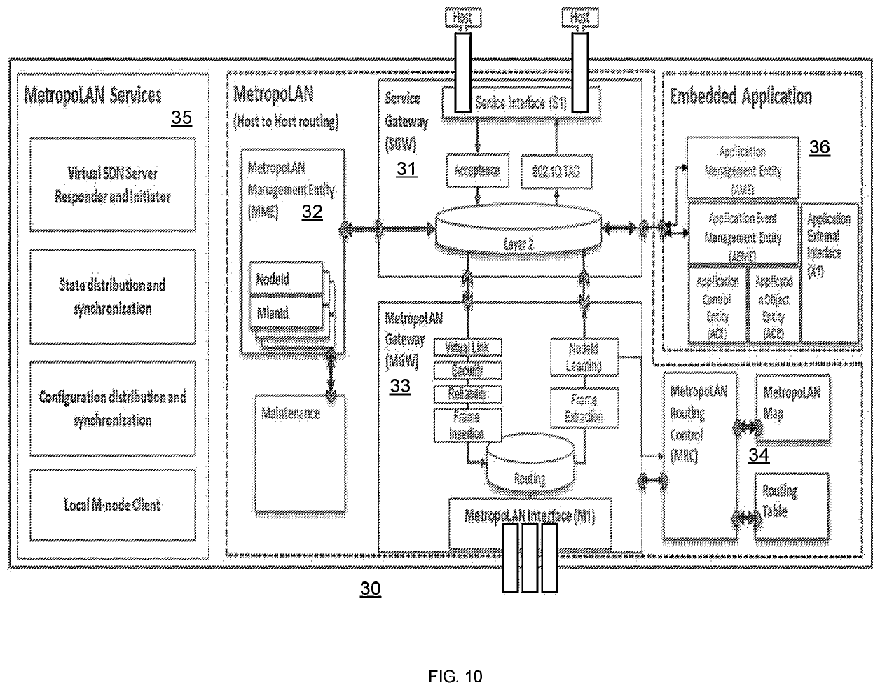

FIG. 10 illustrates an example of the virtual distributed SDN layer 2 switch 30 that is implemented by multiple physical nodes. It includes a service gateway (SGW) 31 that conveys communication between hosts of a group of physical nodes, SGW management 32, a LAN gateway (MGW) 33 that conveys communication between hosts of groups of physical nodes, MGW management 34, LAN services 35, and an embedded application 36.

The LAN services 35 may include virtual SDN server responder and initiator (responds to queries), a state distribution and synchronization (distribution of state metadata between the physical nodes), a configuration distribution and synchronization (distribution of configuration metadata between the physical nodes) and a local M-node client.

The physical nodes are configured to distribute metadata (for example configuration and/or state information) in real time in a continuous or non-continuous but frequency manner.

An example of a distribution may include distributing physical node state (state metadata), and configuration metadata (physical node Config).

Network state may include state information representing relevant state on the network (for example cables health, Loads, Gateways-State etc.)

There may be two types of state:
a. Synchronous state that is distributed to all node and should be available real time (multiple copies).
b. Quarriable state—state is kept on one physical node but can be queried by any node as needed. In this case the physical node may provide an indication that a state variable was modified.

Configuration metadata may include static tables that are configured when network is setup. These tables should be available to all nodes and synchronized when a change occurs in the configuration or on the network (i.e. new box)

There may be two types of configurations:
a. Synchronous configuration—like state mechanism—a copy exists on any node; the system supports mechanism to distribute and synchronize such configuration and must allow large chunks of information to be distributed and synchronized.
b. Quarriable config—Config is kept on one physical node but can be queried by any node as need. In this case the physical node may provide an indication that a configuration variable was modified.

Examples for Main configurations components:
a. MLAN Level configuration
   i. SW and FW images.
   ii. Sub networks configuration.
   iii. Security feature.
b. physical node configuration
   i. Local assignments.
   ii. Geo tag/Coordinated.
c. Port configuration
   i. Subnet assignment.
   ii. POE and physical behavior.

Note: although the physical node and port config may seem local to physical node, they should be kept synchronous on other physical nodes for cases of unit replacement etc.

The network may support virtual server that may be used to:
a. Respond to and handle any M-LAN external access
   i. Configuration read and write.
   ii. Status, diagnostics and other queries.
b. Respond to internally generated events and/or state changes

An external access query may be identified in various manners—for example by IP address (Per physical node cluster), and/or Mac address (Per physical node cluster), and the like.

There may be more than one server each virtual server for different purposes.

In given time that may be multiple concurrent instances responding from multiple physical CPUs on different physical nodes.

Data and state of the network is distributed in real time between the physical nodes. It may include dynamic information that is generated inside the M-LAN during run time.

Examples for such data:
a. Ports errors.
b. CRC count.
c. Links health.
d. physical node overall health.
e. Current consumption by ports or other physical information of the link.
f. Routing state.
g. MAC tables.
h. Failures.
i. Memory of neighbor physical nodes.
j. Connections.
k. Firmware/Software update status.
l. Firmware/Software failures.
m. Log or Any type of diagnostics information.

Data and state that are used for routing decision and any type of network management and synchronized and fully or partially (by request) available on all M-nodes.

A change in state that should be synchronize should trigger synchronization sequence that guaranties that all routing decisions within less than a predefined time period (for example 0.5, 1, 2, 3 seconds and the like) on any part of the network are using the new state.

State synchronization may be managed using algorithm similar to MESI (TBD MSI) coherent data cash for multi-CPU devices where the analogy between cash and M-lane state:
a. Addresses and lines are analog to state elements.
b. Cash size is identical to full state (1:1) so all synchronous state can be replicated on all nodes.
c. State update/change should never impact user traffic on the network or cause any data loss.

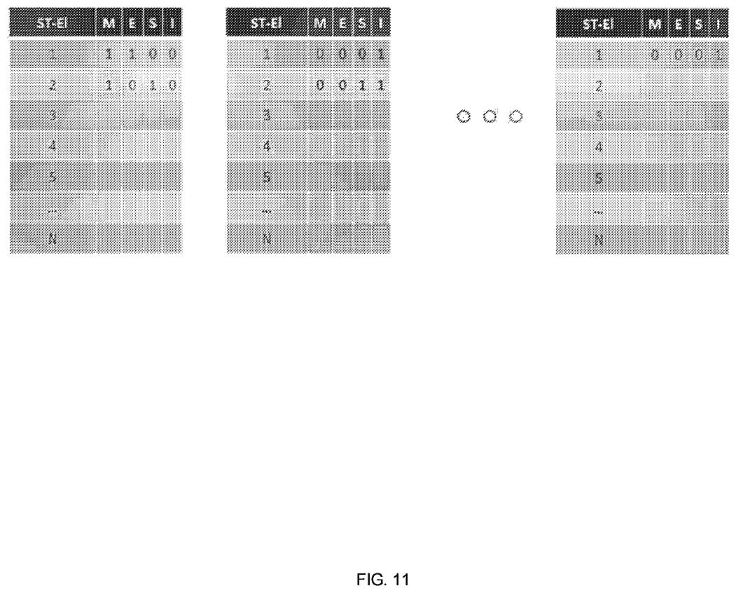

FIG. 11 illustrates the management of physical node statuses using a MESI like protocol.

Configuration has similarities to state but differs from state by exhibiting a very slow change frequency. In addition, the network may store two configuration (active/primary and shadow/golden).

In most cases the configuration is available and fully replicated on all physical nodes.

An update to configuration can be made by the following sequence:
a. Updating shadow.
b. Initiate synch, confirm shadows are synced.
c. Triger delayed transition.

The configuration can be done in the network level, in the physical node level, and the like.

Each physical node can switch to new config individually and the configuration update may create temporal impact to traffic on the network.

The configuration update may be made gradually while leaving consecutive traffic path fully operational with old or new config.

Each physical node CPU may operate as an independent processor addressing few key roles. For example:
a. Emulate the m-LAN virtual server: i.e. Respond and interact with an out of MLAN diagnostics or configuration application.
b. Handle all the local physical node configurations and actions based on triggers (timers, interrupts, external messages, network events).
c. Trigger network update synchronization when needed.
d. Handle Local hardware management, reset sequences, board configurations, diagnostics etc.
e. Act as a local server for advanced debug activities that by pass the virtual server.

The network data is available to the local CPU either directly (local synchronized copy) or indirectly (via handle/pointer/address to unique copy on another node.

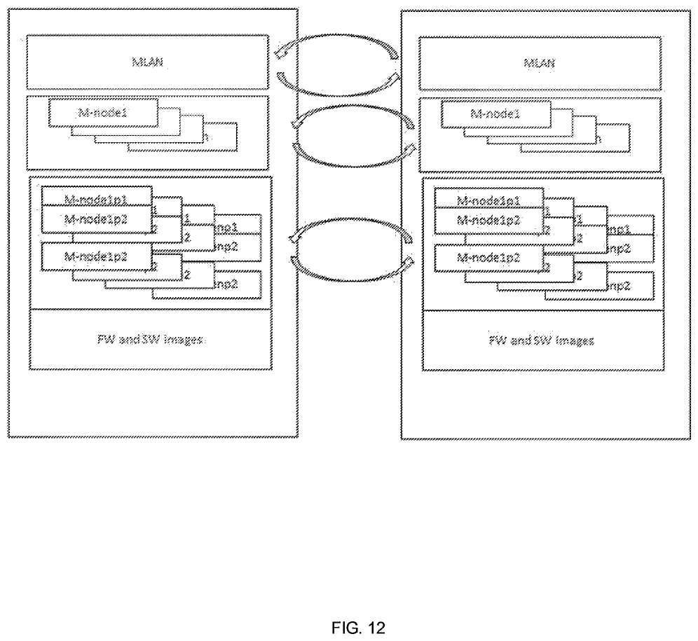

FIG. 12 illustrates the exchange of information at the LAN level, at the physical nodes level, and at the ports level.

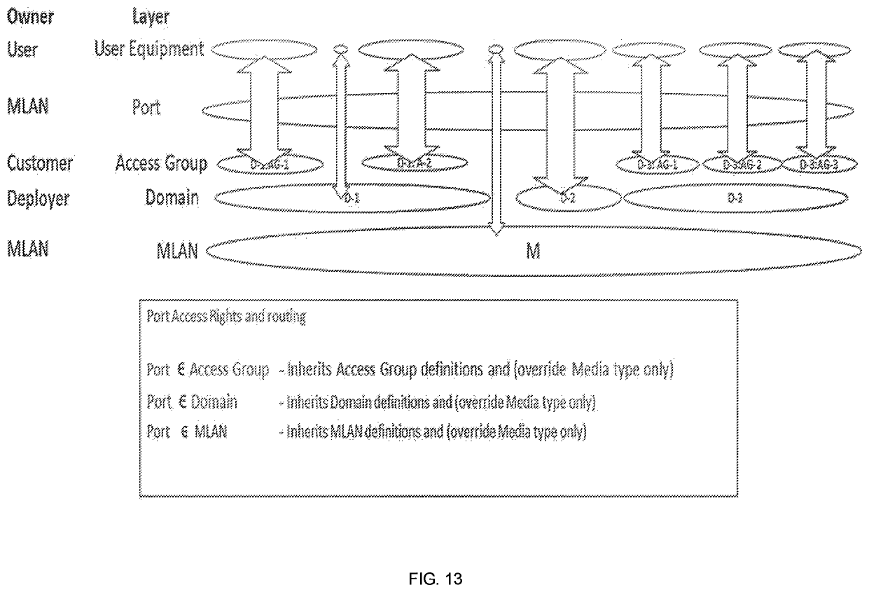

FIG. 13 illustrates access rights of the LAN layer, access domain layer, port layer and user equipment layer.

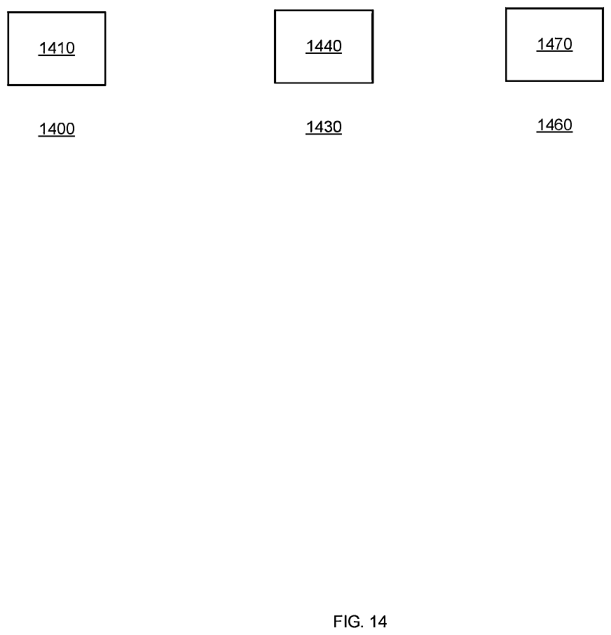

FIG. 14 illustrates example of various methods such a method 1400 for operating a distributed network, the method may include step 1410 of communicating, by multiple physical nodes via multiple links with each other, wherein the multiple physical nodes and the multiple links form multiple redundant paths, wherein at least some of the redundant paths form a daisy chain; interfacing by the multiple physical nodes, via output ports, with external hosts; and supporting, by the multiple physical nodes, software defined networking (SDN).

FIG. 14 also illustrates method 1430 for operating a distributed network, the method may include step 1440 of communicating, by multiple physical nodes via multiple links with each other, reconstructing, by at least two physical nodes of the multiple physical nodes, in real time, a status of all physical nodes of the multiple physical nodes; defining, by the at least two physical nodes, in real time, two different paths from each of the at least two physical nodes to one or more targets.

FIG. 14 also illustrates method 1460 of operating a physical node of a distributed network, the method may include step 1470 of communicating, by a communication module of the physical node, via mesh ports of the physical node, with other physical nodes of the distributed network; storing, by a memory unit of the physical node, status information regarding a status of the physical node and regarding statuses of the other physical nodes of the distributed network; reconstructing, by a processor of the physical node, in real time, a status of all the other physical nodes; and defining, by the processor, in real time, two different paths from the physical node to a target.

There may be provided one or more non-transitory computer readable medium that store instructions for operating a distributed network, by: communicating, by multiple physical nodes via multiple links with each other, wherein the multiple physical nodes and the multiple links form multiple redundant paths, wherein at least some of the redundant paths form a daisy chain; interfacing by the multiple physical nodes, via output ports, with external hosts; and supporting, by the multiple physical nodes, software defined networking (SDN).

Supporting may include operating a SDN compliant network.

There may be provided one or more non-transitory computer readable medium that store instructions for operating a distributed network, by communicating, by multiple physical nodes via multiple links with each other, reconstructing, by at least two physical nodes of the multiple physical nodes, in real time, a status of all physical nodes of the multiple physical nodes; defining, by the at least two physical nodes, in real time, two different paths from each of the at least two physical nodes to one or more targets.

There may be provided a non-transitory computer readable medium that store instructions for operating a physical node, by: communicating, by a communication module of the physical node, via mesh ports of the physical node, with other physical nodes of the distributed network; storing, by a memory unit of the physical node, status information regarding a status of the physical node and regarding statuses of the other physical nodes of the distributed network; and reconstructing, by a processor of the physical node, in real time, a status of all the other physical nodes; and defining, by the processor, in real time, two different paths from the physical node to a target.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A distributed network comprising:
multiple links; and
multiple physical nodes that in communication with each other via the multiple links, to form multiple redundant paths, wherein at least some of the redundant paths form a daisy chain; wherein the multiple physical nodes comprise output ports configured to interface with external hosts; and wherein the multiple physical nodes are configured to supports software defined networking (SDN).

2. The distributed network according to claim 1, wherein at least some link portions of the least some of the multiple links are underground link portions.

3. The distributed network according to claim 1, wherein the multiple physical nodes are configured to exchange, in real time, status information within each other.

4. The distributed network according to claim 1, wherein the multiple physical nodes are configured to exchange, in real time, physical node health information within each other.

5. The distributed network according to claim 1, wherein a physical node of the multiple physical nodes is configured to send, in real time, physical node health information regarding the physical node and regarding neighbors of the physical node.

6. The distributed network according to claim 1, comprising initializing a new physical node with a health score indicative of an untested physical node, and providing the physical node a valid health score only after the physical node is active for at least a predefined period.

7. The distributed network according to claim 1, wherein the multiple physical nodes are configured to exchange, in real time, a packet distribution policy with each other.

8. The distributed network according to claim 1, wherein the multiple physical nodes are configured to exchange, in real time, configuration information within each other.

9. The distributed network according to claim 1, wherein the multiple physical nodes are configured to exchange, in real time, a first type of physical node metadata and to send an indication about a change in a value of a second type of physical node metadata.

10. The distributed network according to claim 1, wherein each physical node of the multiple physical node is configured to reconstruct, in real time, a status of all physical nodes of the multiple physical nodes.

11. The distributed network according to claim 1, wherein each physical node of the multiple physical nodes is configured to define, in real time, two different paths from the physical node to a target.

12. The distributed network according to claim 11, wherein each physical node of the multiple physical nodes is configured to define the two different paths from the physical node to the target, based on a status, generated by the physical node, of all physical nodes of the multiple physical nodes.

13. The distributed network according to claim 11, wherein each physical node of the multiple physical nodes is configured to define the two different paths based on a health of physical nodes of the multiple physical nodes.

14. The distributed network according to claim 11, wherein each physical node of the multiple physical nodes is configured to define the two different paths based on load associated with the multiple physical nodes.

15. The distributed network according to claim 11, wherein each physical node of the multiple physical nodes is configured to define, in real time, two different paths from the physical node to a target for traffic of a first class and is configured to define in real time a single path from the physical node to the target for traffic of a second class.

16. The distributed network according to claim 11, wherein each physical node of the multiple physical nodes is configured to define the two different paths so that the different paths do not share a point of failure.

17. The distributed network according to claim 1, wherein the multiple physical nodes are configured to support the SDN without an assistance of an external SDN manager that is located outside the distributed network.

18. The distributed network according to claim 1, wherein the multiple physical nodes are configured to exchange, in real time, physical node metadata regarding the multiple physical nodes, and to reconstruct a status of the multiple physical nodes, wherein the reconstructed status is associated with access control rules.

19. The distributed network according to claim 18, wherein the access control rules define whether a status of a certain physical node is modified, exclusive, shared or invalid.

20. The distributed network according to claim 1, wherein the multiple physical nodes are configured to provide an SDN layer two switch.

21. The distributed network according to claim 1, wherein the multiple physical nodes comprise groups of physical nodes are configured to provide a SDN architecture that comprises a service gateway configured to convey packets between hosts of a group of physical nodes, and local access network (LAN) gateway that is configured to convey packets between hosts of the groups of physical nodes.

22. A distributed network comprising:
multiple links; and
multiple physical nodes that are in communication with each other via the multiple links;
wherein at least two physical nodes of the multiple physical node are configured to reconstruct, in real time, a status of all physical nodes of the multiple physical nodes;
and to define, in real time, two different paths from the physical node to a target.

23. The distributed network according to claim 22, wherein the multiple physical nodes are configured to exchange, in real time, status information within each other.

24. The distributed network according to claim 22, wherein the multiple physical nodes are configured to exchange, in real time, physical node health information within each other.

25. The distributed network according to claim 22, wherein a physical node of the multiple physical nodes is configured to send, in real time, physical node health information regarding the physical node and regarding neighbors of the physical node.

26. The distributed network according to claim 22, comprising initializing a new physical node with a health score indicative of an untested physical node, and providing the physical node a valid health score only after the physical node is active for at least a predefined period.

27. The distributed network according to claim 22, wherein the multiple physical nodes are configured to exchange, in real time, a packet distribution policy with each other.

28. The distributed network according to claim 22, wherein the multiple physical nodes are configured to exchange, in real time, configuration information within each other.

29. The distributed network according to claim 22, wherein the multiple physical nodes are configured to exchange, in real time, a first type of physical node metadata and to send an indication about a change in a value of a second type of physical node metadata.

30. The distributed network according to claim 22, wherein each physical node of the multiple physical node is configured to reconstruct, in real time, a status of all physical nodes of the multiple physical nodes.

31. A physical node of a distributed network, the physical node comprises:
a communication module that is configured to communicate, via mesh ports of the physical node, with other physical nodes of the distributed network;
a memory unit that is configured to store status information regarding a status of the physical node and regarding statuses of the other physical nodes of the distributed network;
a processor that is configured to reconstruct in real time, a status of all the other physical nodes; and to define, in real time, two different paths from the physical node to a target.

32. The physical node according to claim 31, wherein the physical node is configured to exchange, in real time, with the other physical nodes, physical node health information of the physical node and of the other physical nodes.

33. The physical node according to claim 31, wherein the physical node is configured to send, in real time, physical node health information regarding the physical node and regarding neighbors of the physical node.

34. The physical node according to claim 31, wherein the physical node is configured to initialize itself, when first activated in the distributed network, a health score indicative of an untested physical node, and provide the physical node a valid health score only after the physical node is active for at least a predefined period.

35. The physical node according to claim 31, wherein the physical node is configured to exchange, in real time, a packet distribution policy with the other physical nodes.

36. The physical node according to claim 31, wherein the physical node is configured to exchange, in real time, with the other physical nodes configuration information.

37. The physical node according to claim 31, wherein the physical node is configured to send, in real time, to the other physical nodes a first type of physical node metadata and to send in real time, to the other physical nodes, an indication about a change in a value of a second type of physical node metadata.

38. A method for operating a distributed network, the method comprises:
communicating, by multiple physical nodes via multiple links with each other, wherein the multiple physical nodes and the multiple links form multiple redundant paths, wherein at least some of the redundant paths form a daisy chain;
interfacing by the multiple physical nodes, via output ports, with external hosts; and
supporting, by the multiple physical nodes, software defined networking (SDN).

39. A method for operating a distributed network, the method comprises:
communicating, by multiple physical nodes via multiple links with each other,
reconstructing, by at least two physical nodes of the multiple physical nodes, in real time, a status of all physical nodes of the multiple physical nodes;
defining, by the at least two physical nodes, in real time, two different paths from each of the at least two physical nodes to one or more targets.

40. A method for operating a physical node of a distributed network, the method comprises:
communicating, by a communication module of the physical node, via mesh ports of the physical node, with other physical nodes of the distributed network;
storing, by a memory unit of the physical node, status information regarding a status of the physical node and regarding statuses of the other physical nodes of the distributed network;
reconstructing, by a processor of the physical node, in real time, a status of all the other physical nodes; and
defining, by the processor, in real time, two different paths from the physical node to a target.

41. One or more non-transitory computer readable medium that store instructions for operating a distributed network, by:
communicating, by multiple physical nodes via multiple links with each other, wherein the multiple physical nodes and the multiple links form multiple redundant paths, wherein at least some of the redundant paths form a daisy chain;
interfacing by the multiple physical nodes, via output ports, with external hosts; and
supporting, by the multiple physical nodes, software defined networking (SDN).

42. One or more non-transitory computer readable medium that store instructions for operating a distributed network, by:
communicating, by multiple physical nodes via multiple links with each other,
reconstructing, by at least two physical nodes of the multiple physical nodes, in real time, a status of all physical nodes of the multiple physical nodes;
defining, by the at least two physical nodes, in real time, two different paths from each of the at least two physical nodes to one or more targets.

43. A non-transitory computer readable medium that store instructions for operating a physical node, by:
communicating, by a communication module of the physical node, via mesh ports of the physical node, with other physical nodes of the distributed network;
storing, by a memory unit of the physical node, status information regarding a status of the physical node and regarding statuses of the other physical nodes of the distributed network; and
reconstructing, by a processor of the physical node, in real time, a status of all the other physical nodes; and
defining, by the processor, in real time, two different paths from the physical node to a target.
